(19) United States
(12) Patent Application Publication
(10) Pub. No.: US 2012/0295796 A1
(43) Pub. Date: Nov. 22, 2012

(54) System and Method of Predicting Chemical Interaction and Functionality of Molecules

(75) Inventors: Gerald J. Wyckoff, Overland Park, KS (US); Brian Moldover, Philadelphia, PA (US); Lisa Kenney, Oakland, CA (US); Ada Solidar, Kansas City, MO (US); Jeff Murphy, Lancaster, NY (US)

(73) Assignee: VASSA INFORMATICS

(21) Appl. No.: 13/226,141

(22) Filed: Sep. 6, 2011

Related U.S. Application Data
(60) Provisional application No. 61/379,942, filed on Sep. 3, 2010.

(51) Int. Cl. G06F 19/10; C40B 30/02

(52) U.S. Cl. 506/8; 702/19

(57) ABSTRACT

A system and method of identifying a target molecule that bind to the bioactive site of a protein or protein complex is described. The system and method includes the steps of calculating the information signature of a first molecule that is known to bind to the bioactive site of a protein or protein complex, wherein the information signature is a string of numerical values based on the average distance and physico-chemical properties of each atom of a plurality of atoms in the first molecule, calculating the information signature of each target molecule in a library of target molecules, comparing the information signature of the first molecule to the information signatures of the target molecules, and selecting the target molecules having an information signature that is similar to the information signature of the first molecule.

### CROSS-REFERENCE TO RELATED APPLICATIONS

The present application claims priority under 35 U.S.C. §119(e) to U.S. Provisional Application No. 61/379,942, filed Sep. 3, 2010, the entire disclosure of which is incorporated by reference herein as if being set forth herein in its entirety. Applicant is entitled to this claim of priority specifically under 35 U.S.C. §119(e)(3), as the day that is 12 months after the filing date of such provisional application (being Sep. 3, 2011) falls on a Saturday, and the next succeeding secular or business day being Tuesday, Sep. 6, 2011 (Sep. 4, 2011 being a Sunday, and Sep. 5, 2011 being a Federal holiday within the District of Columbia).

### STATEMENT REGARDING FEDERALLY SPONSORED RESEARCH OR DEVELOPMENT

This invention was made with government support under 1 R41 GM 088922-01A1, awarded by the National Institutes of Health. The government has certain rights in the invention.

### BACKGROUND OF THE INVENTION

Protein-protein interactions (PPIs) represent a large class of potentially important therapeutic targets in drug discovery. These types of interactions regulate numerous important processes, such as cell-cycle regulation, growth and development, neural development, viral infection and response, and many others. As such, they touch on almost all aspects of human biology and disease. Such interactions are mainly disrupted by antibodies, smaller peptides or other large molecules, such as peptoids. Currently, small molecules are preferred as therapeutics over larger molecules, as several small molecules have been shown to block protein/protein interactions in functional assays, in animals, and/or in humans. Small molecules are also preferred for reasons associated with modes of delivery, as well as cost.

Unfortunately, standard drug screening methods have had little success at finding such molecules. Numerous properties of each protein must be considered not only to identify the proper binding site between the proteins, but also to identify the exact atoms involved in modulating the interaction. This can be very difficult, as protein interaction surfaces tend to appear relatively featureless when examined via conventional structural analysis tools. Methodologies such as computational alanine scanning have proven to be somewhat effective, but cumbersome. Thus, wide applicability of this method has not been demonstrated. Methods utilizing yeast-based expression systems have also been utilized, but again with mixed results. Toolkits, such as ROSETTA, have been making in-roads into identification of protein-protein interaction hot-spots, and the success of some of these methodologies has given credence to the concept of targeted drug design for these surfaces. While binding and functional screens are known to pick up PPIs, it is most likely that researchers are screening molecules from a chemical space that is suboptimal. The fact remains that there is simply little a priori knowledge of where to search for lead molecules in chemical space, and searching the entirety of chemical space remains challenging from both a monetary and time perspective.

To improve the efficiency of choosing a chemical space for screening small molecules that interact with conventional ligand/receptor sites, numerous in silico approaches have been developed. However, such an approach has not been successfully developed for identifying small molecules that inhibit PPIs. The challenge, arises primarily from two factors. First, it has proven difficult to identify interaction “hotspots” in protein-protein interactions, because the functional surfaces tend to be relatively flat. Second, once a hotspot has been identified, it has proven challenging to find a specific small-molecule inhibitor for these targets. Current methods rely on binding-energy scanning and complex modeling, which is time-consuming, and in some cases, requires special knowledge of a particular interaction.

Thus, there is a need in the art for systems and methods of identifying new small molecules and novel binding partners for known bioactive sites in drug development. There is also a long felt need in the art for a screening tool that utilizes information content to evaluate the chemical structures of proteins, small molecules, chemical fragments, and natural products to find functional surfaces in proteins and small molecules that may interact with those surfaces. The present invention satisfies these needs.

### SUMMARY OF THE INVENTION

A method of calculating an information signature of a molecule is described. The method includes the steps of determining the location of each atom of a plurality of atoms in a molecule, generating a numerical value for each of a plurality of atoms of the molecule based on at least one of the valence shell content, atomic number and atom reactivity, comparing the location of each atom to the reactivity between adjacent atoms, and multiplying the differences in reactivity to the average distances of adjacent atoms.

In one embodiment, the determination of the location of each atom is based on spatial or structural information data. In another embodiment, the structural information data is taken from a PDB or SMILES file. In another embodiment, the information content tracks at least one of the molecule's structural and physic-chemical properties. In another embodiment, a low or negative numerical value is indicative of a region or atom where information is sparse. In another embodiment, a high numerical value is indicative of a region or atom where information is dense. In another embodiment, a region of atoms that shift between high and low numerical values is indicative of an active site of the molecule. In another embodiment, the molecule is a small molecule. In another embodiment, the molecule binds to a protein or protein complex. In another embodiment, the protein or protein complex is an esterase, a hydrolase, a kinase, an oxidoreductase, an ion channel or a nuclear receptor. In another embodiment, the molecule disrupts a protein-protein interaction.

A method of identifying a target molecule that binds to the bioactive site of a protein or protein complex is described. The method includes the steps of calculating the information signature of a first molecule that is known to bind to the bioactive site of a protein or protein complex, wherein the information signature is a string of numerical values based on the average distance and physico-chemical properties of each atom of a plurality of atoms in the first molecule, calculating the information signature of each target molecule in a library of target molecules, comparing the information signature of the first molecule to the information signatures of the target molecules, and selecting the target molecules having an information signature that is similar to the information signature of the first molecule.

In one embodiment, the method further includes filtering the library of target molecules using known physic-chemical, ADMET, or other drug-like properties. In another embodiment, the information signature of the first molecule comprises a numerical value for each of the plurality of atoms of the molecule that is based on at least one of the valence shell content, atomic number and atom reactivity. In another embodiment, the protein or protein complex is an esterase, a hydrolase, a kinase, an oxidoreductase, an ion channel or a nuclear receptor. In another embodiment, the target molecule disrupts an interaction of the protein or protein complex with another protein.

Also described is an automated system for calculating an information signature of a molecule, The system includes a software platform that determines the location of each atom of a plurality of atoms in a molecule based on collected spatial or structural information data, generates a value for each of a plurality of atoms of the molecule based on valence shell content, atomic number and atom reactivity, compares the location of each atom to the reactivity between adjacent atoms, and multiplies the differences in reactivity to the average distances of adjacent atoms.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings. The patent or application file contains at least one drawing executed in color. Copies of this patent or patent application publication with color drawing(s) will be provided by the Office upon request and payment of the necessary fee.

FIG. 1 is a heatmap representation of information content for conotoxin; RED shows high information content compression, blue shows low information content compression, and green shows regions that are being excluded from a current analysis (in this case, a heteroatom), Regions of large shifts in information content are of interest and map to suspected functional regions of this conotoxin,

FIG. 2 is a graphical representation showing how conotoxin G-scores plot across the linear amino acid sequence. It is this atom-by-atom G-score that can be searched for drug discovery work.

FIG. 3 is a chart of a typical search, exemplified by a Lipitor search vs. a 600,000 compound library. The data shows that a score of 6 or 7 yields 21 unique results from the compound library search. Adding matches at a score of 8 would add 30 more compounds, and 100 more would be added at a score of 9.

FIG. 4 depicts the analysis of binding of a compound, G2L (3′-o-methyoxyethyl-guanosine-5′-monophosphate) to the Hmg-CoA reductase site. Panel A shows the molecular interactions of G2L with the HMG-CoA reductase binding site. Pymol was used for graphics, labels, and identifying H-bonds between ligand and residues in binding site. Panel B shows the molecular interactions of atorvastatin to the Hmg-CoA reductase site (). Panel C shows a comparison table of interactions conserved between A and B. An asterisk indicated a critical bond found in the atorvastatin-HMG-CoA reductase interactions.

FIG. 5 is a diagram demonstrating that numerous protein-protein interactions have been identified as potentially important in prostate cancer progression due to androgen. Each of these interactions target portions of the AR. Most of these interactions occur in or near the ligand binding domain (LBD) (FIG. 4). The LBD is present in both the A and B forms of Androgen receptor. In addition, there is a dimerization binding domain (DBD) that contributes to the functionality of androgen receptors by allowing them to complex to form dimmers. One androgen receptor then binds to DNA via the NTD, while the other binds to a ligand via the LBD.

FIG. 6 is a flowchart demonstrating how the system of the present invention may further be used to identify small molecules that interact with a specific surface area on either of the proteins in each interaction.

FIG. 7 is a structural representation of Lipitor, and its interaction with the liver enzyme HMG-CoA reductase.

FIG. 8 is a heatmap of Lipitor, where red regions indicate high information content, and blue indicate low information content. The system of the present invention correctly identified the binding region where Lipitor interacts with its target HMG-CoA reductase and predicts most of the important interacting atoms that were also determined experimentally.

### DETAILED DESCRIPTION

It is to be understood that the figures and descriptions of the present invention have been simplified to illustrate elements that are relevant for a clear understanding of the present invention, while eliminating, for the purpose of clarity, many other elements found in systems and methods of identifying and/or predicting small molecules and novel binding partners for known bioactive sites in drug development. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present invention represents a unique method for the identification of novel compounds with affinity to bind to their respective targets. This approach affects both the attrition rate and timelines associated with the preclinical drug discovery process, and impacts human health by advancing the ability to identify new therapeutic modalities for the treatment of disease.

The present invention includes application software and a platform for in silica identification of small molecules and novel binding partners for known bioactive sites of larger proteins and protein complexes, and for identification of small molecules that otherwise disrupt protein-protein interactions. The present invention also includes a system and method for identifying chemical fragments, small molecules, and natural products as binding partners for known bioactive sites of larger proteins and protein complexes, and for identification of small molecules that otherwise disrupt protein-protein interactions. The present invention can identify functional protein/protein interaction surfaces, and small molecules that interact with a specific surface area on any of the proteins in such interactions.

The present invention further includes a method of coding proteins and small molecules for extracting information content that can be used to predict small molecules that will act as binding partners for known bioactive sites of larger proteins and protein complexes, or as inhibitors of PPIs. The method of the present invention is more robust than existing methods in the art, because it relies on fewer assumptions regarding calculated binding characteristics and energy fields around structures. By searching for and comparing informatically similar strings, large numbers of comparisons can take place quickly and efficiently. In other words, instead of utilizing extensive, complex models that must be screened exhaustively, the present invention can perform a large number of less complex queries quickly and obtain a broad set of possible hits that can then be screened via modeling and docking mechanisms. The present invention can ab initio predict novel binding partners for chemical ligands that cannot otherwise be predicted by existing methods.

The present invention may incorporate data collected from NMR-based HSQC assays to determine if the identified small molecules disrupt a PPI or other interaction. Further, the present invention can identify two compounds, such as small molecules or fragments, which are able to disrupt binding of proteins involved in CRPC-related interactions utilizing NMR-based HSQC as a measure of binding and binding disruption as a lead discovery platform for PPL For example, if one of the compounds disrupted the PPI with an IC50 of 10 μM or less, it may be deemed a success.

Because throughput of the system is only limited by available computational resources, the ability to screen many new targets and identify potentially novel therapeutics brings significant value. Through the use of cloud computing and cluster virtualization, searches performed by the present invention can be scaled to any size compound database, inexpensively and efficiently, bringing ultra-high throughput compound discovery to both large pharmaceuticals and to smaller biotechnology companies. The system of the present invention may serve as a tool for high-throughput identification of drug-like small molecules directed against targets of therapeutic interest. This may serve two commercially strategic purposes. First, it increases value of the system platform by providing users with a pre-analyzed database of potential lead compounds directed against the most economically important drug targets. Second, it provides input to the biological screening program which may both validate these targets in vitro.

The system of the present invention can analyze any sort of molecule. For example, the origin of molecules suitable for analysis can be biological, such as proteins or antibodies, or chemical, such as small molecules, fragments, nucleotides, peptides, and larger bioactive molecules (such as holo-enzymes) on the same scale. This is particularly useful for organizations engaged in work across the spectrum of drug development. For example, if a company has both an antibody and small-molecule-based drug in development for the same known disease-associated target, the present invention can evaluate both molecules (and modifications to those molecules) for functional shifts using the same tools. Further, the present invention is suitable for both High Throughput Screening (HTS), and Fragment-based lead discovery (FBLD) approaches. This is a fundamental shift from existing methods in use within the industry.

Generally, the system of the present invention evaluates each atom and region of a molecule to represent the molecule as a series of values. This works by calculating the information content of a molecule, utilizing spatial information (taken from PDB, converted SMILES, or other structural information files) to locate an atom within the molecule. Each individual atom may be converted using a lexicon that accounts for features such as, by non-limiting example, valence shell content, atomic number, and reactivity of the atom. The location of each atom is then compared, as well as the reactivity between adjacent atoms. The average of the distance, weighted utilizing the physico-chemical factors for each atom, is the G-score for each atom. A string of &scores may then be searched across a database of compounds that have previously had G-scores calculated for each atom. A string of similar G-scores across compounds can denote physical and functional similarity. G-scores track not just structural properties, but also unique physico-chemical properties of molecules, and can thus be utilized in library searches.

### Information Content

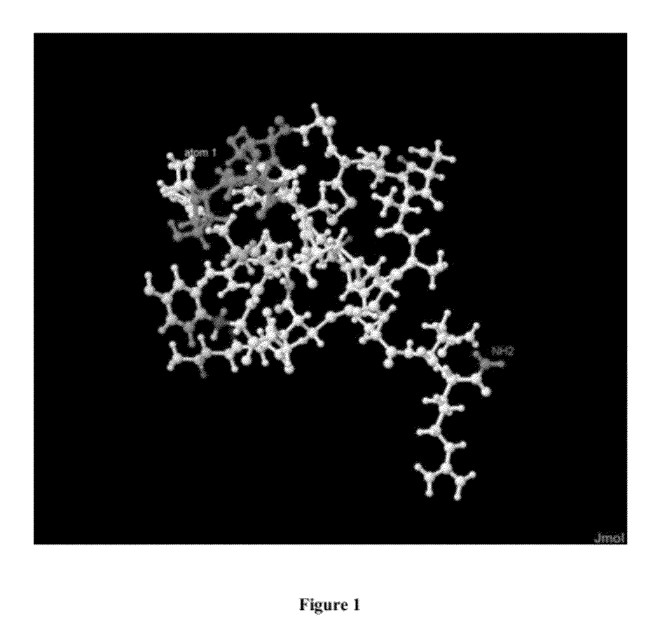

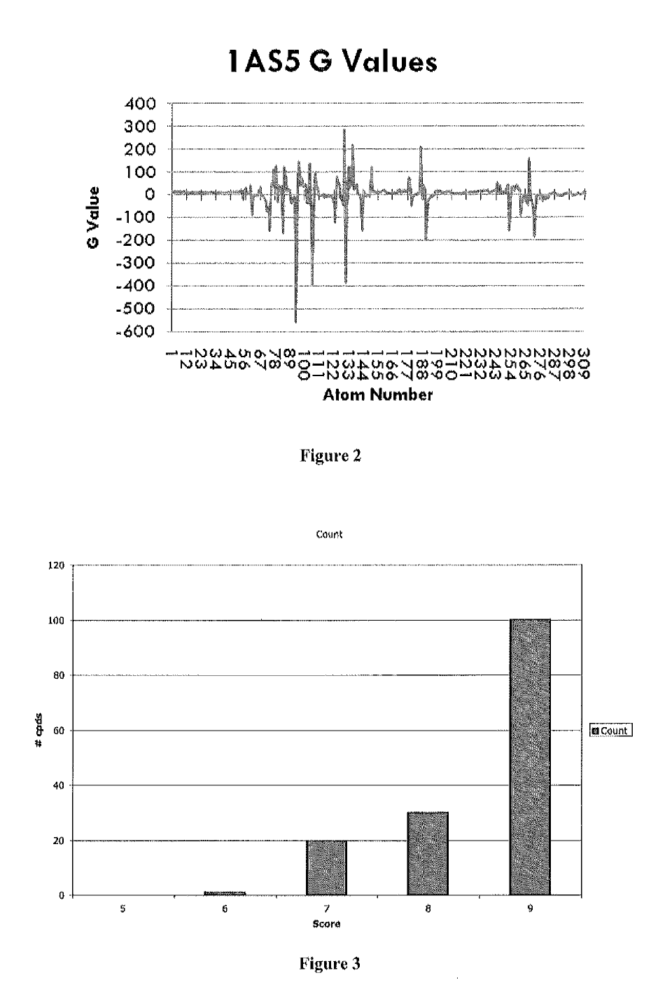

Information content is a measurement of a unit's (e.g., a small molecule) compressibility versus a theoretical maximum. Units with high information content are not as compressible as those with low information content. The system of the present invention works by using structural data in combination with atom data from standard structural files such as PDB or SMILES, which is the end result of experimental structural determination (via NMR or crystallography), or in silica structural determination (threading or modeling studies), Each atom is then converted into a chemical information lexicon value, which takes into account the valence shell content, atomic number, and reactivity of the atom. The comparison of these values among adjacent atoms in a molecule, and to the overall information potential of the molecule produces that molecule's “information signature,” which can then be compared to compound databases to uncover informatically similar (rather than searching for structurally similar) compounds. For example, FIG. 1 depicts the information content signature of Conotoxin. The information content is plotted against the structure (blue represents low and red represents high information content). As shown in FIG. 2, the information content is plotted graphically.

The system of the present invention uses formulae to measure information content to perform two crucial tasks; (1) quantifying a channel's information potential (channel capacity: the amount of information that a channel is capable of transmitting); and (2) determining the amount of information contained in a signal at the beginning or end of its transmission. The present invention uses both of these to generate a profile of the target molecule. For example, measurements of a chemical or biological entity's information potential are: 1) weighted versus density of information at specific sites as the algorithm scans the entity; and 2) creation of an abstraction of a molecule that shows the contribution of each atom in the molecule to the ability of the molecule to be compressed and represented as a linear string. A low or negative value means that a region or atom is highly compressible (i.e., information is sparse); a high value means the region or atom is hard to compress (i.e., information is dense). Rapid fluctuations between highly compressible and non-compressible atoms generally characterize functional surfaces, or other notable features of proteins and small molecules.

When a compound is chosen for analysis, “G” scores for each atom are determined. G scores define areas of high or low information content and can be visualized on a structure (FIG. 1). Areas of rapid shifts between high and low information content often signify active sites of the molecule (FIG. 2).

The present invention visualizes molecule surfaces using scripts to feed G-score values into Pymol for visualization. Pymol allows for the 3D visualization of protein structures, and scripts allow for the placement of atom-by-atom G-score values on to these 3D images.

After visualization, a set of proteins is examined with known functional interaction surfaces to determine what G-score characteristics are consistent with a functional surface identification. While it is anticipated that visual scanning of protein-protein surface yields clues as to how to identify interaction surfaces, this process may be automated. For this purpose, a discriminant function analysis can be constructed that categorizes atoms into one of three bins based on G-score, location, and other variables that can be gathered from a PDB file, for example. A test set of 85 protein-protein interactions from the literature can be utilized for this purpose. Identified protein-protein interaction surfaces in the proteins, as well as non-PPI surfaces, can be notated. This training set may be utilized to build the initial discriminant function analysis. Atoms can be assigned to one of three bins, such as likely in an interaction surface (LIKELY), likely not to be in an interaction surface (UNLIKELY) and neither likely nor unlikely to be in an interaction surface (NEUTRAL), for example. A runs analysis may be carried out to determine the number and category of G-scores that are typically found within a protein-protein interaction surface in the set. An a posteriori principal components analysis can also identify the variables that most strongly correlate with placement of an atom within a PPI surface. A set of 20 protein-protein interactions identified from the literature may then be utilized as a validation set, and protein-protein interaction surfaces within this data set can be identified. Visualization of these protein-protein interaction surfaces may occur within pymol and each PPI surface may be manually inspected.

### Libraries for Screening

In order to effectively look for molecular interactions, the present invention may utilize a compound library for in silico searches. For example, the present invention may utilize a RCSB small molecule database, as well as a ZINC library. This chemical space includes libraries of small, drug-like compounds with good rule-of-five characteristics and sizes that are well represented in marketed compounds (the so-called “Goldilocks” set) to compounds that are large and have poor RO5 properties, but are nonetheless present within the drug space. As contemplated herein, the bounds of any particular chemical space may be predefined or user defined, and may include the entirety or any portion of any suitable compound library as would be understood by those skilled in the art.

For example, the present invention may incorporate NCI's Diversity set into the library, when looking at prostate cancer. The addition of the NCI diversity panel molecules into the analysis gives a ready pipeline for accessing novel therapeutic compounds that may be identified by the system of the present invention. The NCI data set represents compounds that are suspected to have utility in cancer treatment, but in many cases their method of action is un-studied or poorly understood. In addition, these compounds are all readily available for use in in vitro effectiveness studies. In another example, the present invention may incorporate PDB protein data files into the library. In addition to the large small-molecule library, structural information may be incorporated from the entire protein database record from PDB. This not only enables more rapid protein-protein searches, but also allows a user to look for potential cross reactivity of small molecules via a reciprocal search.

The present invention provides a new type of molecular descriptor using calculations of information content of the small molecule being analyzed. As explained herein, this descriptor takes into account the atoms, bonds and their positions in 3-dimensionsional space. The present invention includes a database of these molecular descriptors as calculated for each of the structures in the database. In one example, roughly 600,000 structures in the Zinc “goldilocks” subset of the database. This subset of structures was filtered for drug-like properties from the larger Zinc database.

### System Algorithms

The present invention includes use of an algorithm that provides rapid similarity searching of this database using a query descriptor, and a scoring metric which allows ranking of the search results. The system of the present invention utilizes these algorithms to search a database of drug-like molecules and identify novel compounds which are shown to interact with known drug targets. These interactions have been validated using computational molecular docking. In addition, several highly promising compounds have been taken from these studies and further validation using biological screens has been performed.

The algorithm was developed utilizing concepts from information content and fingerprint analysis, with an eye towards performing large-scale bioinformatic searches to identify compounds with similar information content signatures. Input/output is designed to be both flexible and scalable with the ability to load thousands of compounds per second into the program from both local and web-based libraries. Output is similarly robust with the potential to pull hundreds of thousands of chemical information signatures from the database (via either a search tool or a rapid data “dump” of all database contents). Standard file formats are utilized throughout.

Without limitation, the algorithms incorporated into the system of the present invention may be written in Java, such as Java 1.6 using the NetBeans IDE. The technical environment may be a mix of desktop and server hardware running the Linux, Mac OSX, and Windows operating systems, for example. Code versioning may be performed using CVS. Systems for bug tracking and reporting may also be used. In particular embodiments, dependencies on external libraries and software for data conversion, data storage, searching, and retrieval of results may or may not exist, such as with use of OpenBabel, BioReadSeq, Apache, MySQL and associated libraries, for example, A number of custom scripts may be written in PERL to support data input, output, and transformation.

The system platform of the present invention thus includes a robust, commercial-grade software platform. The platform may consist of at least two tiers. For example, the first tier may be the server-side back-end, which may not be exposed to users, and consists of the software for generating the G-score profiles, database searching and scoring, and pipeline processing of data, as well as any queue or systems management tools required for data processing. This may comprise the computational engine for the algorithms of the system of the present invention. A relational database management system may provide a mechanism for storage of both the chemical structure library and results. Access control may be implemented at the database level to ensure secure partitioning of information. The second tier may be a “client-side” front end, and may consist of a graphical interface to the database. Features of this interface may include: 1) a mechanism for securely logging into the database; 2) the ability to visualize and manipulate chemical structures and associated properties; 3) sorting, querying, and data manipulation tools; and 4) the ability to save compound lists and annotations. The system may operate on standard hardware and may include all necessary processing, storage, networking architecture or any other computing equipment as would be understood by those skilled in the art.

Standard input/output file formats are supported and graphical extensions using scripted commands allow for a variety of graphical presentations of data, permitting us to maximize user options. Existing code development environments are sufficient for development of the server-side back-end. Separate branches may be maintained for both research and production versions of the system software, and versioning may be performed using the OpenSource Concurrent Versioning System (CVS), for example. The CVS repository may be maintained on a dedicated system, and mirrored to a development system as well as to a backup device for archival storage and disaster recovery. A web-based system for defect, or “bug”, tracking may be used based on the Bugzilla system released under the Creative Commons License and in use by many commercial organizations, for example.

The existing chemical structure library may be stored using MySQL 5.5, which is an Open Source relational database management system. The schema may hold basic information related to structure derived from either the PDB or Zinc databases, or any other database suitable for use as would be understood by those skilled in the art. For development of a production platform, the database schema may include significant changes as would be understood by those skilled in the art, and incorporation of additional information on chemical properties of importance in drug discovery, such as physical properties, drug-likeness (i.e. Pfizer rules of five), or other content as defined by user feedback, may be added or included as needed. A combination of OpenBabel and custom code may be used for bulk conversion and loading of compound structures into the database.

As with any use or construction of an information database, data security is paramount. Access control may be required and implemented at both the server and client interfaces. For example, from the client side, when a user connects to the database, their identity may be determined by the host from which the user connects and the username specified. The system may grant privileges according to identity and access level. Access may further be based on a combination of username, password, and IP address. The database information may be maintained within tables. Access to information contained in the tables may be regulated, such as with control over direct access to the tables, and also through views. Views and privileges assigned to the views can be created to limit users to only see specified portions of data contained within a table. This will allow for partitioning of data between users as well as providing views of data based on licensing terms. Role-based authentication may also be used to limit what actions can be performed on the database. Typical roles for access may include, for example, administrator, user, programmer and operator. Furthermore, an audit trail and log may be maintained for any or all database transactions. In the event that a user continues to have concerns over data security, a custom version of the database may be replicated to a dedicated server of their choosing.

The front end client may provide the interface to the database. For example, the TIBCO Spotfire Lead Discovery as a commercial solution can be integrated into the system platform of the present invention. TIBCO Spotfire Lead Discovery provides a highly visual and interactive environment for exploring the effects of chemical structure on biological activity. It allows the user to cluster compounds based on assay results or chemical properties and to save and manage lists of interesting compounds. This brings an additional set of functionality to the system platform without requiring the development of a proprietary interface. Spotfire is a standard software package familiar to most researchers and is a de facto standard in the pharmaceutical industry.

Technical validation of the platform may be based on two major criteria: back-end or infrastructure testing (functionality), and front-end or screening capability (utility). Functionality validation consists of systems and regression testing using a test harness developed for this purpose. A standard test set of structure data was developed and is used to validate the analytical functionality of the software prior to any system version release. Utility testing may consist of development and use of test cases, end-user feedback from beta testers, and user acceptance testing with real-world scenarios.

The production platform may be a multicore server running the Linux operating system, for example. This system may be housed in a data center or co-location facility that can provide complete IT, networking, security infrastructure, support personnel, and provide room for further expansion. Service level agreements for backup and disaster recovery may be put into place. Additionally, Amazon EC2 Cloud Computing may be used to create a virtualized computer cluster and provide on-demand access to high performance computing as needed. The algorithms of the present invention work by looking at the overall information content (“compressibility”) of a particular molecule. It does this from a two-fold perspective. First, it utilizes spatial information to locate an atom within a molecule. The spatial information is taken from the source PDB file (or converted SMILES file, etc). Each atom is then converted into a chemical information lexicon value, which takes into account features such as the valence shell content, atomic number, and reactivity of the atom. The location of each atom is compared and the reactivity between adjacent atoms is compared. The average of these distances, multiplied by the reactivity differences, is the “G-score.” G-scores for the backbone of the molecule (defined as the alpha carbons in a protein or the longest carbon chain in an organic compound) are processed as follows: the average for connected non-main-chain molecules is added to the connected main carbon atom, summed across the backbone and averaged. The result is the “M-score.” The M-score can be calculated as the average across all molecules (M1) or the average across the carbon chain (M2).

G therefore represents whether a particular atom is enhancing or detracting from the information content of the entire molecule. M1 is the average information content attainable across the entire molecule, while M2 represents, loosely, the information content if only the carbon backbone is considered (which may be desirable for peptide-specific studies).

The PDB bitwise similarity search algorithm operates by concatenating a model's G values into a single bit field and then running bitwise comparisons between different models and subsections of models. The number of bitwise differences between the comparator and the candidate model is used to assess similarity. A logarithmic scale is used to give greater weight to bit differences in the higher-order positions of the bit field.

The system database contains a listing of all PDB files and models loaded into the system. As each file is loaded, the G-score is computed and stored in the database. Once the file has been loaded, and all G-scores computed, the list of G-scores are extracted from the database. The scores may then be rounded to the nearest thousandth (which is the maximum resolution used in the PDB file) and scale by about 1000. This is done to convert the G-scores from decimal to integer notation so as to avoid having to operating on the bitwise IEEE floating-point representation of the scores. Once the G-scores are converted to 32 bit integers, they are concatenated into a single linear bit field and stored back into the system database for easy recall.

For example, when generating the bit fields, assume there is the following molecule, with G scores:

| | | | | | | | Ele- |
|---|---|---|---|---|---|---|---|
| Atom # | Atomic | G | Name | X | Y | Z | ment |
| 2414 | 7 | 65.93364782 | N | 40.014 | −14.628 | 6.03 | N |
| 2415 | 6 | 69.89459542 | CA | 40.31 | −16.018 | 5.655 | C |
| 2416 | 6 | 70.99743542 | C | 41.66 | −16.44 | 6.239 | C |
| 2417 | 6 | 73.27638433 | CB | 40.372 | −16.147 | 4.131 | C |
| 2418 | 6 | 75.4690475 | CG | 39.024 | −16.506 | 3.502 | C |
| 2419 | 6 | 72.08201803 | CD1 | 37.832 | −16.111 | 4.123 | C |
| 2420 | 6 | 81.72439948 | CD2 | 38.981 | −17.228 | 2.303 | C |
| 2421 | 6 | 74.42657582 | CE1 | 36.599 | −16.436 | 3.544 | C |
| 2422 | 6 | 85.19509051 | CE2 | 37.748 | −17.552 | 1.724 | C |
| 2423 | 6 | 81.24658179 | CZ | 36.557 | −17.156 | 2.344 | C |
| 2424 | 8 | 77.07011835 | O | 42.386 | −17.251 | 5.646 | O |
| 2425 | 6 | 66.3392611 | CM | 43.145 | −14.966 | 7.256 | C |
| 2426 | 8 | 69.79531204 | OXT | 42.098 | −15.9 | 7.477 | O |

Next, extract the G scores and round:

### G

65.934

69.895

70.997

73.276

75.469

72.082

81.724

74.427

85.195

81.247

77.070

66.320

69.795

Next, convert to an integer by multiplying by 1000. The following table shows the corresponding binary representation of the 32-bit integer value for G.

| G_int | G_bin |
|---|---|
| 65934 | 10000000110001110 |
| 69895 | 10001000100000111 |
| 70997 | 10001010101010101 |
| 73276 | 10001111000111100 |
| 75469 | 10010011011001101 |
| 72082 | 10001100110010010 |
| 81724 | 10011111100111100 |
| 74427 | 10010001010111011 |
| 85195 | 10100110011001011 |
| 81247 | 10011110101011111 |
| 77070 | 10010110100001110 |
| 66339 | 10000001100100011 |
| 69795 | 10001000010100011 |

After obtaining the binary representation, it is concatenated into one long bit string: 100000001100011101000100010000011110001010101010101 . . . Now it is ready to do comparisons between the different bit fields.

The comparison function uses a sliding window concept to move the subsection of the model being used as the basis for the comparison (the comparator) across the entirety of the model being compared to (the candidate). Since each G value is, at this point, 32 bits in length, the window slides by 32 bits each time the comparison is done. If it is found that the comparison has yielded a similarity score less than a cut-off value specified by the user, the result is stored for later output.

For example, Comparator: 10001111000111100 Candidate: 100000001100011101000100010000011110001010101010101 The first iteration would consider 10001111000111100 compared to 10000000110001110 as follows:

10001111000111100 Comparator

10000000110001110 Candidate region

### ------------------ 00001111110110010 Exclusive-OR

The exclusive OR operation shows that there is considerable bitwise differences (9 bits of difference). Next, ‘slide’ to the next 32 bits and repeat the comparison. In the above example, the comparator is only 32 bits long (the equivalent of a single atom's G-score) and this is typically not the case. The system application allows for the selection of arbitrary length comparators.

Consider the following G-scores and corresponding bit fields:

| G_int | G_bin |
|---|---|
| 1 | 00000000000000000000000000000001 |
| 1025 | 00000000000000000000010000000001 |
| XOR | 00000000000000000000010000000000 |

A simple exclusive OR would lead one to, correctly, conclude that the two numbers differ by only one bit (bit #10). However, the difference in G-scores is several orders of a magnitude. In order to avoid misleading results—for example the above two scores being rated as “highly similar” even though they are not—the bit differences are given more weight in the higher order bits of the integers. This is done by multiplying by 10 each time one moves 8 bits higher into the integer.

Using the above example, the XOR bit field that is the result of the comparison is broken into four 8-bit regions and assign each region a weight:

| Weight: | 1000 | 100 | 10 | 1 |
|---|---|---|---|---|
| Region: | 00000000 | 00000000 | 00000010 | 00000000 |
| Bit count: | 0 | 0 | 1 | 0 |
| Adjusted: | 1000 * 0 | 100 * 0 | 10 * 1 | 1 * 0 |

Summing the scores for each region yields a total score of 10 for that comparison. Next, repeat for each subsequent 32 bit region in the candidate and take the average of Σ adjusted to compute score for the complete multi-atom region that the user selected.

Using a similarity score of about 6 to 8 yields a good set of results. This is due to the weighting mentioned above.

The lowest order 8 bits of the G_bin are weighted by a factor of one. These bits can represent 255 numbers. Since the G value is scaled by 1000, that means the lowest 8 bits of G_{—} bin present 0.000 thru 0.255 in the G value.

In these lowest 8 bits, there's a possible bit variation of 8 between two G values. For example, if you have a G value of 20.000 and 20.255, then there will be 8 bits of difference between those two scores, all of the difference occurring in the lowest 8 bits. Since those bits are weighted by one, the similarity score for those two G values is 1*8 or simply 8. What this means is that specifying a similarity tolerance of less than 8 implies that, on average, the G values in the comparator and candidate varied by less than 0.256. If the variation between the G values spills over into the next 8 bits, and since those are weighted by 10, the similarity score would range from 10 through 80 (from 1 to 8 bits of difference weighted by 10). Similarly, variation in the next 8 bits yields similarity scores in the range of 100-800. The final 8 bits correlate to similarity scores in the range of 1000-8000.

In terms of magnitude, the first 8 bits represent G value variation of less than 0,256, The next 8 bits indicate average variation in G values of 0.256 to 65.535.

The following table summarizes this:

| Similarity Score Range | G value variation |
|---|---|
| 0 to 8 | 0.000 to 0.255 |
| 10 to 80 | 0.256 to 65.535 |
| 100 to 800 | 65.536 to 16777.215 |
| 1000 to 8000 | 16777.216 to 4294967.295 |

Given the above, one can see why low similarity scores offer the best results when using the bitwise algorithm described herein.

Note that the above table shows absolute variation and not average. In reality, since the G values are averaged (and thus the similarity score) over a number of atoms, scores of 9, 81 through 99, etc, are possible and likely. A score of 9 would indicate that there was enough variation in the 0.256 to 65.535 range to pull the average up above 8. A more realistic summary would be:

| Similarity Score Range | Average G value variation |
|---|---|
| 0 to 8 | 0.000 to 0.255 |
| 9 to 80 | 0.256 to 65.535 |
| 81 to 800 | 65.536 to 16777.215 |
| 801 to 8000 | 16777.216 to 4294967.295 |

For example, a typical search, exemplified by the Lipitor search vs. the 600,000 compound library as described in Example 2 hereinbelow, yields results that may be summarized as seen in FIG. 3. As depicted in FIG. 3, the Lipitor match is trimmed against itself from the results, but that is a key value that helps validate any search. The data shows that a score of 6 or 7 yields 21 unique results from the compound library search. Adding matches at a score of 8 would add 30 more compounds, and 100 more would be added at a score of 9. These are all relatively credible matches that could be reported as possible interaction partners.

As the algorithms of the present invention provide a numeric representation of structure and reactivity, it can be searched more easily than just a structure, while retaining more information. In addition, the M-score (or scores) can give a succinct summary of the compression a specific molecule can achieve.

### Target Analysis

As previously explained, the compound screening process incorporated by the present invention involves library screening using a known ligand, usually through structure, substructure or motif-based searches, against a large set of small molecules followed by molecular docking and ranking of results. In addition, the database can be filtered a priori using known physicochemical, ADMET, or other drug-like properties. The present invention is unique in the approach to the library screening component of the in silico approach to drug discovery.

For example, because of the algorithms used in identifying compounds in a virtual library, the probability of identifying novel compounds and compound classes which bind to therapeutic targets of interest are dramatically increased. In one embodiment, the structure library is derived from a ZINC set and are pre-filtered for drug-like properties based on physicochemical parameters.

As contemplated herein, the present invention is suitable for analysis of any therapeutic target, including esterases, hydrolases, kinases, oxidoreductases, ion channels and nuclear receptors, for example. A representative sample may be taken for each class prioritized by the availability of structural information and the relative market size for targets within the class. Particular targets in these classes, including exemplary drugs, are presented in Table 1.

TABLE 1
Exemplary Targets for Screening

| Class | Target | Drug (e.g.) | PDB |
|---|---|---|---|
| Esterases | PDE5 | Sildenafil | 1UDT |
| Hydrolases | HIV Protease | e.g. Saquanivir | 1HXB |
| | (aspartyl protease) | (Invirase) | |
| | ACE | Captopril (Capoten) | 1UZF |
| Kinases | EGFR | Erlotinib (Tarceva) | 1M17 |
| | c-ABL | Imatinib (Gleevec) | 1IEP |
| Oxidoreductases | Cox-2 | Celebrex | 3KK6 |
| | HMG-CoA | Statins (e.g. | 1HWK |
| | Reductase | Lipitor) | |
| Ion Channels | Caᵥ1 L-type | (Neurontin) | * |
| | Naᵥ1.2 | Lamotrigine | * |
| | | (Lamictal) | |
| Nuclear | PPAR-gamma | Rosiglitizone | 1I7I |
| Receptors | Estrogen receptor | Tamoxifen (e.g. | 3ERT |
| | | Valodex) | |

Table 1 denotes exemplary therapeutic targets prioritized by number of successful drugs targeting human proteins. Esterases, Hydrolases, Kinases and Oxidoreductases make up about 50% of successful small molecule compounds. Ion channels make up 6%, but as membrane proteins lack structural data for ligand-receptor complex in the PDB. Nuclear receptors constitute 6% of successful drug targets.

The following process may be applied for the analysis of each target. From the PDB, the structure of the therapeutic compound bound to the receptor may be obtained. This will serve as the reference for in silico validation of binding for structures identified by the system of the present invention and subsequently docked into the receptor. The therapeutic compound may be analyzed using the system algorithms to develop the molecular profile based on information content. This profile may be used to search the virtual structure database and identify a subset of structures meeting the threshold established for similarity (e.g. a similarity score of 5) as well as other filters for druggability. Putative ligands meeting these criteria typically number about 50-100, and may be validated through docking studies. Docking may be performed using Autodock automated docking software, for example. Autodock requires ligands to be in pdbqt format. The prepare_ligand4.py script from ADT may be used to add hydrogens, merge non-polar hydrogens, assign partial charges, and define rotatable bonds for ligands. When required, OpenBabel may be used to convert file formats. The macromolecule may be prepared from the PDB file using Autodock Tools (ADT). ADT may be used to prepare the receptor coordinate files for AutoGrid and AutoDock. Grid dimensions are based on the identified regions of intermolecular interaction of the ligand within the receptor. Therefore a series of trial docking may be performed to optimize parameters for docking. The benchmark for optimization is a docking pose which recapitulates binding energy and intermolecular contacts found in the crystallographic structure. After completion of a virtual screen, the docking log file (.dlg) may be parsed using a Python script to extract the calculated free energy of binding. These results may be used to rank and select specific binding poses from each ligand for further analysis. Molecular interactions, such as bond distances and hydrophobic interactions, can be calculated and displayed using Pymol, and these may be compared against the original ligand-receptor data to determine binding quality. These results may then be entered into the database, along with the docking parameters and associated metadata.

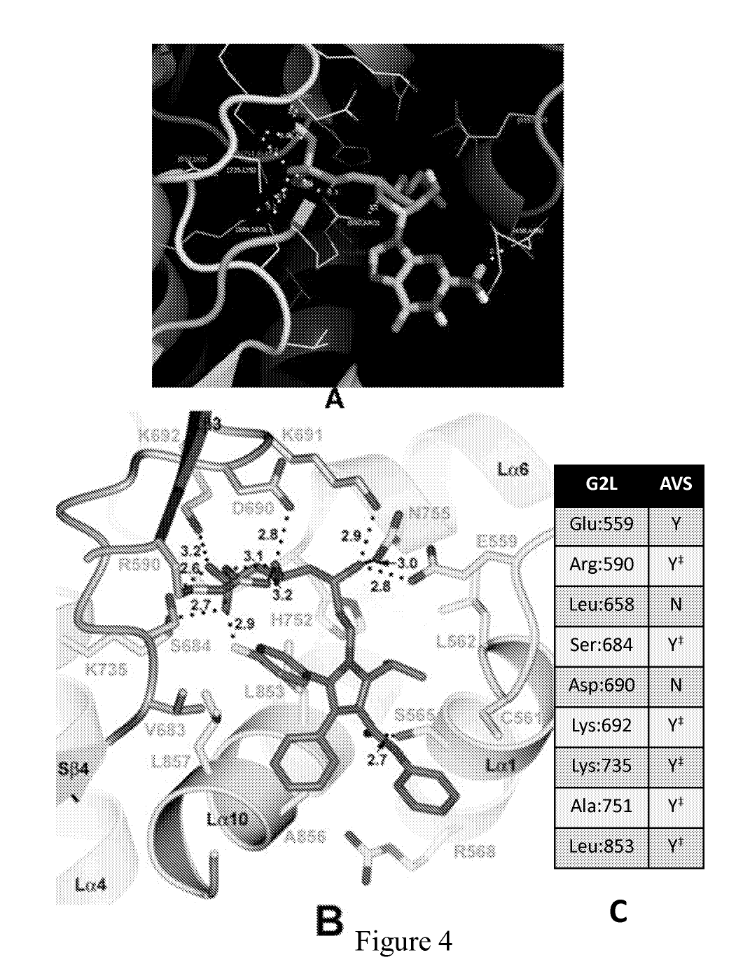

An example of this methodology is generally depicted in FIG. 4. Specifically, FIG. 4 depicts the analysis of binding of a compound, G2L (3′-o-methyoxyethyl-guanosine-5′-monophosphate) to the Hmg-CoA reductase site. Panel A shows the molecular interactions of G2L with the HMG-CoA reductase binding site. Pymol was used for graphics, labels, and identifying H-bonds between ligand and residues in binding site. Panel B shows the molecular interactions of atorvastatin to the Hmg-CoA reductase site (). Panel C shows a comparison table of interactions conserved between A and B. An asterisk indicated a critical bond found in the atorvastatin-HMG-CoA reductase interactions.

### Hotspot Detection on Molecular Surfaces

Prostate cancer is a major health concern among American males, with a lifetime incidence rate of approximately 1 in 11. It is currently the second leading cause of cancer mortality among men, causing approximately 30,000 deaths each year. Studies suggest a majority of these of prostate cancer-related deaths are androgen dependent. Androgen dependent prostate cancer almost always results in death. In fact, it is the leading cause of prostate cancer related deaths.

Initial attempts at treating this cancer by depriving it of androgen sources (by castration) proved futile because there are so many sources of androgens. Therefore existing strategies are aimed at altering the ability of the cancer to respond to androgen. One method that may work to utilize this knowledge is the targeting of androgen receptors on the cancer and the subsequent disruption of androgen binding. This disruption may occur by targeting a variety of protein-protein interactions.

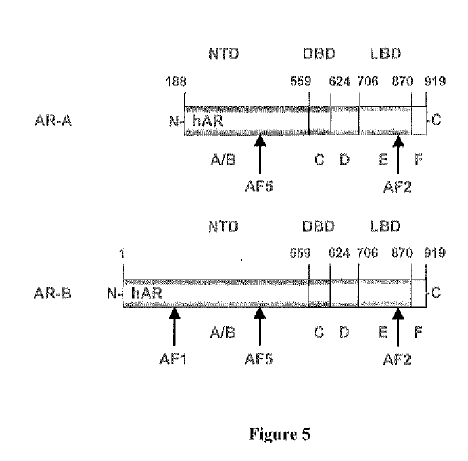

Numerous protein-protein interactions have been identified as potentially important in prostate cancer progression due to androgen. Each of these interactions target portions of the AR. Most of these interactions occur in or near the ligand binding domain (LBD) (FIG. 5). The LBD is present in both the A and B forms of Androgen receptor. In addition, there is a dimerization binding domain (DBD) that contributes to the functionality of androgen receptors by allowing them to complex to form dimmers. One androgen receptor then binds to DNA via the NTD, while the other binds to a ligand via the LBD. While disruption of dimerization is an attractive target for potential therapeutics, disruption of ligand binding would likely have fewer side effects and could potentially yield benefits for treatment of prostate cancer prior to the need for castration as a treatment option.

The present invention includes a methodology for targeting protein-protein interactions for disruption as a tool in drug development. This methodology includes the detecting of hotspots on PPI surfaces. CRPC can also be targeted by utilizing PPI involving AR. As CRPC is a major cause of cancer mortality and treatment options are lacking, the present invention affords a new line of treatment for pharmaceutical companies. Examination of the results can be carried out utilizing HSQC as a way of eventually building a pipeline that could feed in to modern SAR by NMR screening technologies.

As contemplated herein, the present invention also includes the development of: 1) Hotspot detection capabilities to directly compete with commercial products (such as ROSETTA) in the analysis of protein-protein interactions for drug development; 2) Greater screening, validation, and commercialization of AR-focused PPI disruptors for the treatment of CRPC; and 3) Application of PPI technology to primary screening for the development of novel IP targeting other diseases with hard-to-target protein-protein interactions where drug development has been slowed, such as with Huntington's Disease and Alzheimer's Disease,

### Additional Uses of Information Content

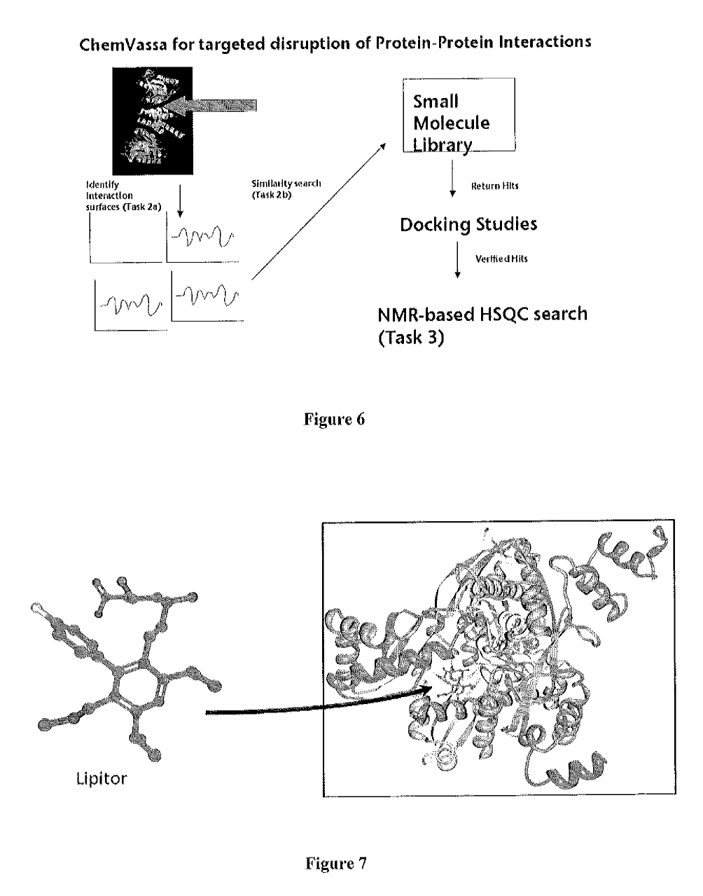

As depicted generally in FIG. 6, the system of the present invention may further be used to identify small molecules that interact with a specific surface area on either of the proteins in each interaction. Exemplary interactions for examination may include:

1) SMAD4/AR

2) SMAD3/AR

3) STAT3/AR

4) ARA-70/AR

5) BRCA1/AR

6) BAG1/AR

7) Testicular receptor 2/AR

8) Testicular receptor 4/AR

9) PTEN/AR

10) Caveolin 1/AR

11) HSP90/AR

12) COX5B/AR

13) SART3/AR

14) TGFB1/AR.

While this represents a large number of potential protein-protein interactions to focus on, the more rapid in silico screening capabilities of the present invention can look at this larger number of interactions to find a small, focused group of small molecules that can be tested at the bench for activity. This allows a user to cast a broad net for interactions important in CRPC and further validates utilization of the present invention for looking at PPI, where a client might have a broad set of targets that they would want screened up front utilizing a more rapid in silico methodology.

Each protein-protein interaction may be run through the discriminant function analysis described herein to determine where the protein-protein interaction surface is on the proteins, and subsequently validated through examination of data from the literature for each interaction, The discriminant function analysis may be utilized in conjunction with the runs test to find the portions of each protein that will be used to search for likely small molecule interactors. Once a specific set of atom G-scores has been found, the data is incorporated into the search methodology.

The search program allows for the identification of G-score strings similar to the input query string. In the case where disruption of a protein-protein interaction is sought, a search from one molecule may identify small molecules that are likely to interact with the contrary, partner molecule.

While for 15 interactions, the user would normally carry out thirty searches (one for each partner in the 15 interactions), in this example the androgen receptor is common to all of the PPI detailed above. Therefore, even though a large number of PPI is being examined, fewer searches are needed, as the androgen receptor is likely binding to some of these proteins through the same ligand binding domain,

Small molecules that are identified as being similar to one protein within a protein-protein interaction above can be docked and modeled utilizing Autodock. Binding poses and energies will be calculated and interaction models for each can be visualized in PyMol. Those that bind with free-energies similar to those proposed (from the literature or from docking models) for the PPI above can be scored as potential disruptors of the PPI and sent for further study.

The present invention may also be used for the evolutionary interpolation of chemical information for estimating potential target toxicity/cross-reactivity, such as to determine potential toxicity and non-specific reactivity of GPCR-targeted lead compounds, for example. Of around 350 GPCRs within humans that bind endogenous ligands, only about 40 structures have been calculated. Although the system of the present invention generally relates to structural calculations, its abstracted G-score data lends itself more easily to mathematical extrapolation than do complete structures. Therefore, a phylogenetic and evolutionary approach may be utilized to allow the system of the present invention to determine which GPCR-targeted compounds are likely to have cross-reactivity and more potential toxicity. The present invention may therefore target specific GPCRs for small molecule development with low cross-reactivity.

To achieve this, parsimony trees of GPCR evolution may be built, utilizing amino acid sequence as the basis for evolutionary extrapolation. Known structures for endogenous GPCRs may be placed in the context of the phylogenetic tree (above) and tag GPCRs with GO terms and known targeted compounds. Threading and homology modeling for GPCRs with unknown structures in the tree may be performed, and all structures run through the system. A phylogenetic distance tree of system derived G-scores may then be developed. Points of congruence and discongruence can be compared between this tree and the evolutionary parsiomy tree described above.

The system may provide an analysis of known and lead compounds for GPCRs. Known cross-reactivity may be mapped to evolutionary and G-score distance trees and correlated with GPCR G.O. term. A prospective test may be developed using known toxicity and reactivity of targeted compounds. Clade identity information (both evolutionary and g-score) may be utilized as a weighting factor for a Principle components analysis. A PCA can be built that can be used to place lead compounds into a matrix that determines their likely toxicity/cross-reactivity. The ultimate product may be a chart showing where lead compounds fall in relation to known-good and known-bad GPCR-targeted compounds. This will allow the development of a statistical measure determining the likely levels of toxicity and cross-reactivity in new lead compounds. To do this, both a training set of toxicity data (with the potential that these could be run blind to validate the method described above), and a test set of lead compounds may be required. For the most relevant analysis and the greatest ease in evaluating the results, these data sets may be provided in a standard format (e.g., SMILES, SDF, etc.) for import to the system. After delivery of this data, all analysis will be performed by the system.

The present invention can also be used for examination of the products of antibody 5. affinity maturation experiments or random mutagenesis experiments. For example, differences that are found after random mutagenesis or affinity maturation experiments can be mapped onto structures of the starting molecules according to the systems and methods described herein. Particularly, the present invention provides for the mapping of differences in G-scores from “starting” to “ending” molecules after mutation. The mutations can thus be assessed as to their likely impact on the functional changes seen in a molecule, such as proteins or antibodies. This can further lead to the targeted design of better antibodies or proteins in subsequent experiments, or provides the “reversion” of mutations that did not have an effect on the functional outcome, leading to lower numbers of changes in these molecules. This simplifies the evaluation of molecules as any side-effects/unwanted activity would be able to be mapped directly to the few changes that had a functional effect more quickly.

### EXAMPLES

The invention is now described with reference to the following Examples. These Examples are provided for the purpose of illustration only, and the invention is not limited to these Examples, but rather encompasses all variations which are evident as a result of the teachings provided herein.

### Example 1: Utilization of NMR-Based HSQC to Validate Potential Small Molecules

In this example, the disruption of binding of several of these Androgen receptor interactions utilizing NMR HSQC overlay spectra is tested. Commercial expression vectors for Androgen receptor are available, either in whole or in part. If an inhibitor of androgen receptor binding for any of the targeted protein-protein interactions seems highly viable after in silico modeling and docking studies, the best two predicted inhibitors can be taken and expressed and purify both members of the interaction. Any expression vectors suitable for the examination of proteins such as Caveolin, CaM, Cox5B, BRCA1, STAT3, TGFB1, HSP90, and BAG1, for example, may be used as would be understood by those skilled in the art. If the need arises, only the relevant regions from these and other proteins may be expressed and purified.

NMR based HSQC assays rely on labeling the proteins and plotting their NMR spectra in two dimensions based on H1 and N15 shifts. Each protein is labeled and examined alone in solution, The two dimensional spectra may be observed. The proteins are then mixed together in solution. Binding of the two proteins shifts the two-dimensional spectra in a predictable manner. Binding can be deduced from this shift. This is the basis for SAR by NMR assays.

Small molecule may be introduced into the labeled solution and binding evaluated. A shift in the peaks of the two base proteins would allow for the determination of whether binding had been disrupted. This assay has several advantages over other potential assays. First, it does not rely on developing an activity assay for each and every protein-protein interaction in which there is interest. Secondly, it can be utilized to detect inhibition even when binding is weak, as it often is with fragments. HSQC can be utilized to do kinetics of compounds, and concentrations for typical proteins fall in the range of about 5 mM.

To find at least two small molecule compounds that were shown via HSQC to disrupt a specific protein-protein interaction involved in CRPC, at least one of these would have to have an IC50 of less than 10 μM within the HSQC assay. The following steps may be taken in this method: 1) Development of statistical assay for protein-protein interaction surfaces; 2) Identification of protein-protein interaction surfaces within 15 AR-based CRPC-related interactions; 3) In silico Modeling/Docking of identified potential interactors and acquisition of small molecule compounds; 4) Testing of binding of several identified inhibitors utilizing NMR-based HSQC; and 5) Analyzing results.

### Example 2: Lipitor

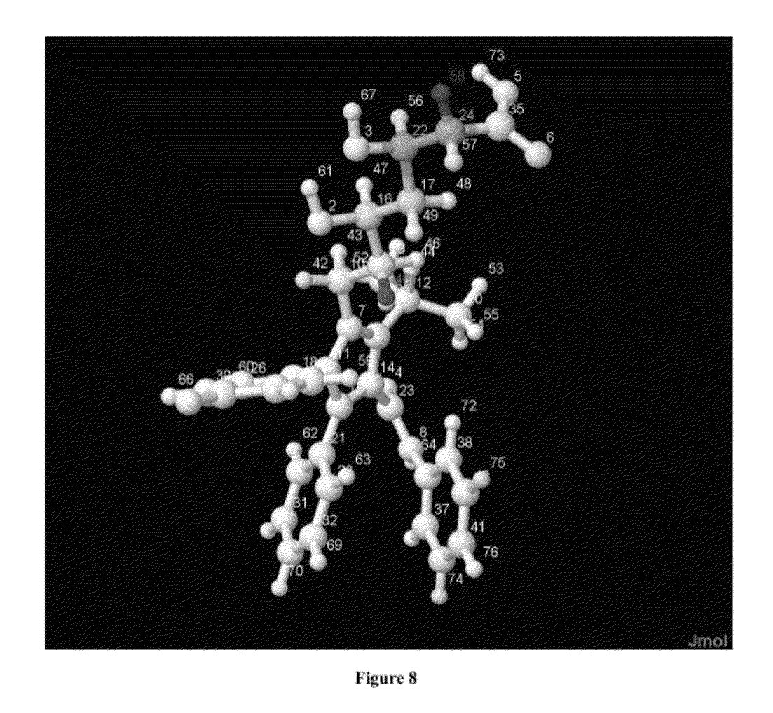

As depicted in FIG. 7, Lipitor works by binding to and inhibiting the liver enzyme HMG-CoA reductase, It was chosen as a test molecule because it is commercially valuable, because crystal structures of HMG-CoA reductase in complex with six statins are available, and because all marketed HMG-CoA reductase inhibitors are structurally similar. Information content was calculated for Lipitor for the creation of an information signature, and is depicted in FIG. 8 as a heatmap. As shown in FIG. 8, red regions indicate high information content, and blue indicate low information content. The system of the present invention correctly identified the binding region where Lipitor interacts with its target HMG-CoA reductase and predicts most of the important interacting atoms that were also determined experimentally.

A 600,000-ligand library was searched using Lipitor's information signature. Results were categorized as: Known Binders, False Positive, or Novel. From the search results it was discovered that about 20% were known binders, about 40% were novel results, and about 40% were false positives. From this, ten previously unknown compounds were found that could be tested for functionality at the bench. None of these were identifiable by existing methods. The resulting search reliably pulled related statins from the library if the binding region was used as search input, demonstrating that there is a shared set of physical properties among the hits provided by the system of the present invention. Thus, the present invention can identify structurally similar hits even in the absence of structural information.

Known Binders: In some cases, results were pulled that were not statins and not structurally similar to Lipitor that, however, are known binders of HmG-CoA reductase. For example, Coenzyme A was returned as a search result even though it is not structurally similar to Lipitor. However, as CoA binds HinG-CoA reductase, it is not a negative result and suggests that the algorithms incorporated into the system of the present invention are also tracking a functional property of HmG-CoA reductase binding, not just a physical one.
False Positives: Some results were returned that do not bind HmG-Coenzyme A reductase and are not structurally similar to Lipitor. For example, Vancomyacin was returned as a search result, although it is not structurally similar to Lipitor and does not bind HmG-CoA reductase. False positive results fell into two categories: complete non-binders, and cases where a portion of the molecule would likely bind, but cannot due to steric hindrance.
Novel Results: Novel results are not structurally similar to Lipitor, but appear via modeling to be capable of binding HmG-CoA reductase in a manner similar to Lipitor; approximately 40% of the search results fell into this category. These results were validated by examining affinity and electrostatic contacts.

Novel hits ranged from those where binding seems very good, but little biological information is present, to cases where binding seemed quite good and biological information was present that provided insight into the possible mechanism for the ligand function. For example, both 3′-o-methyoxyethyl-guanosine-5′-monophosphate (G2L) (FIG. 4A) and Cholic Acid were returned as novel search result hits. Each binds to the HinG-CoA reductase molecule in a manner similar to Lipitor.

### Example 3: Tarceva

### Chemical Fingerprint Analysis

In addition to the structural similarity search, searches were performed utilizing the Tanimoto coefficient for similarity searches of chemical compounds. The concept here was to determine if the system analysis was determining chemical compounds that are similar to ones that may be found using a more conventional fingerprint analysis.

Two different methods were implemented to test this. The first method was to create a tanimoto coefficient (fingerprint) library locally using OpenBabel. While this method would allow for the creation of arbitrary databases, it is inefficient. However using this method specifically for atorvastatinfeholic acid, it was shown that the tanimoto coefficients are not appreciably similar. The second methodology has the benefit of being both simpler to carry out and easier to evaluate. The tanimoto coefficient search database set up by Pubchem was utilized to determine if any of the search results were found using a fingerprint search using Tanimoto coefficients and default similarity. Here, again, it was shown that the system results do not show up in this public search protocol.

### Tarceva as a Test Case Molecule

After running through the atorvastatin test case, it was decided to use a more difficult molecule to determine if the system of the present invention would continue to produce legitimate results. Tarceva was perceived as a “difficult” molecule because of the amount of knowledge about it's structure (the structure is not as well determined as Lipitor), the nature of where it binds (it binds in an ADP binding site on it's principal ligand), and the nature of anti-cancer drugs in general, where cross-reaction is very common.

For all these reasons, it was expected that the system might fail utilizing Tarceva as an input search parameter. The system of the present invention was used to see if the binding location of Tarceva could be determined, and the system produced a similar result; low information content G-score strings characterized the known binding region. However, a search utilizing the entire binding site produced only compounds already known or suspected as binders; that is, AMP, ADP, and ATP. To determine if it could produce novel results, the binding region was split into two pieces and lowered our search affinity; this produced a set of molecules for further analysis that was filtered (large molecules that were unlikely to bind were filtered out) and three molecules (out of 11 hits, including the three known binders) were sent for docking studies. Two of these appeared to be relatively solid theoretical hits; however, there was no biology to suggest a reason or mechanism of action for these potential binders. Structure and fingerprinting analysis did not return the two “novel” results, showing that again that the system of the present invention produced a clear set of novel compounds for further analysis.

The Tarceva results show clearly, however, that while the present invention may be able to produce novel hits, there is a need for a larger chemical library particularly when dealing with more difficult or specialized compounds where known properties of the molecule limit potential matches from the current, focused library used for testing and evaluation.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A method of calculating an information signature of a molecule, comprising:
determining the location of each atom of a plurality of atoms in a molecule;
generating a numerical value for each of a plurality of atoms of the molecule based on at least one of the valence shell content, atomic number and atom reactivity;
comparing the location of each atom to the reactivity between adjacent atoms; and
multiplying the differences in reactivity to the average distances of adjacent atoms.

2. The method of claim 1, wherein the determination of the location of each atom is based on spatial or structural information data.

3. The method of claim 2, wherein the structural information data is taken from a PDB or SMILES file.

4. The method of claim 1, wherein the information content tracks at least one of the molecule's structural and physic-chemical properties.

5. The method of claim 1, wherein a low or negative numerical value is indicative of a region or atom where information is sparse.

6. The method of claim 1, wherein a high numerical value is indicative of a region or atom where information is dense.

7. The method of claim 1, wherein a region of atoms that shift between high and low numerical values is indicative of an active site of the molecule.

8. The method of claim 1, wherein the molecule is a small molecule.

9. The method of claim 1, wherein the molecule binds to a protein or protein complex.

10. The method of claim 9, wherein the protein or protein complex is an esterase, a hydrolase, a kinase, an oxidoreductase, an ion channel or a nuclear receptor.

11. The method of claim 1, wherein the molecule disrupts a protein-protein interaction.

12. A method of identifying a target molecule that binds to the bioactive site of a protein or protein complex, comprising:
calculating the information signature of a first molecule that is known to bind to the bioactive site of a protein or protein complex, wherein the information signature is a string of numerical values based on the average distance and physico-chemical properties of each atom of a plurality of atoms in the first molecule;
calculating the information signature of each target molecule in a library of target molecules;
comparing the information signature of the first molecule to the information signatures of the target molecules; and
selecting the target molecules having an information signature that is similar to the information signature of the first molecule.

13. The method of claim 12, further comprising filtering the library of target molecules using known physic-chemical, ADMET, or other drug-like properties.

14. The method of claim 12, wherein the information signature of the first molecule comprises a numerical value for each of the plurality of atoms of the molecule that is based on at least one of the valence shell content, atomic number and atom reactivity.

15. The method of claim 12, wherein the protein or protein complex is an esterase, a hydrolase, a kinase, an oxidoreductase, an ion channel or a nuclear receptor,

16. The method of claim 12, wherein the target molecule disrupts an interaction of the protein or protein complex with another protein.

17. An automated system for calculating an information signature of a molecule, comprising a software platform that determines the location of each atom of a plurality of atoms in a molecule based on collected spatial or structural information data, generates a value for each of a plurality of atoms of the molecule based on valence shell content, atomic number and atom reactivity, compares the location of each atom to the reactivity between adjacent atoms, and multiplies the differences in reactivity to the average distances of adjacent atoms.

18. The system of claim 17, wherein the structural information data is taken from a PDB or SMILES file.

19. The system of claim 17, wherein the molecule is a small molecule.

20. The system of claim 17, wherein the molecule binds to a protein or protein complex that is an esterase, a hydrolase, a kinase, an oxidoreductase, an ion channel or a nuclear receptor.
